(19) United States
(12) Patent Application Publication
(10) Pub. No.: US 2010/0144422 A1
(43) Pub. Date: Jun. 10, 2010

(54) Multiple game interfaces for gaming devices

(75) Inventor: Kathleen Nylund Jackson, Scituate, MA (US)

Correspondence Address: Precedent Gaming, Inc., 51 Williamsburg Lane, Scituate, MA, 02066, US

(73) Assignee: Precedent Gaming, Incorporated

(21) Appl. No.: 12/590,836

(22) Filed: Nov. 13, 2009

Related U.S. Application Data
(60) Provisional application No. 61/199,285, filed on Nov. 14, 2008.

(51) Int. Cl. A63F 9/24; A63F 13/00

(52) U.S. Cl. 463/20; 463/30

(57) ABSTRACT

A slot machine processor and a video monitor screen are provided on which symbols may be provided in a grid for use in a multi-stage video slot game. The game stages are played sequentially, with separate predetermined sets of symbols being provided for at least two game stages. A first symbol set is provided for at least a first game stage, the first symbol set comprising at least one specifically-themed symbol. A second symbol set is provided for at least a second game stage, the second symbol set comprising at least one specifically-themed symbol that is predeterminedly-related to the at least one specifically-themed symbol in the first symbol set. Symbols in at least a third game stage may be a combination of symbols from the first and second symbol sets. Final symbol arrays in each game stage are analyzed by the processor, and any winning combinations are paid according to predetermined rules and/or paytables.

### RELATED APPLICATION DATA

This application claims priority from U.S. Provisional Patent Application No. 61/199,285 filed Nov. 14, 2008, and having the Title MULTIPLE GAME INTERFACES FOR GAMING DEVICES.

### BACKGROUND OF THE INVENTION

1. Field of the Invention

The present invention relates to a′video slot symbol game suitable for use in casinos and other gaming enterprises. The invention further relates to video gaming play that provides multiple wagerable game interfaces and wherein the interfaces may be evaluated for wins both individually and interactively.

2. Background of the Art

Gaming machines, whether providing video poker or slot games, have grown exponentially in terms of numbers in the last twenty years, as have the revenues generated by such devices. It is estimated that more than 75% of any U.S. casino's revenue is now provided by gaming machines as opposed to table games.

It is well recognized in the gaming industry that players may tend to easily tire of repetitive slot machine games, so manufacturers must constantly develop new game features to stimulate player interest. There is a continuous need for innovative game features that will attract new players as well as keep regular players amused and therefore willing to continue playing the game. Since in virtually every casino game there is a house advantage, the longer a player remains playing at a machine, the larger the casino's profit. In addition, the length of time it takes to wager, play and finish a game is also a factor that determines how much the casino will win. The more games that can be played per hour means higher profits for the house.

Various attempts in prior art have been made to invent slot machine games with novel features that provide the ability to play different games, multiple games at once and/or more games per hour.

U.S. Pat. Nos. 7,156,735 and 6,656,040 (Brosnan, et al.) describe parallel games on a gaming device in which two or more game outcomes may be presented simultaneously to the player on the gaming machine. The game outcome presentations for two or more of the games may appear to interact. However, the game outcomes determined by the gaming machine are independent of one another and do not depend on the game outcome presentation.

U.S. Pat. No. 6,860,810 (Cannon, et al.) discloses a gaming machine which is configured for mutually concurrent play of a plurality of games of chance on a single display screen. The method of conducting a wagering activity includes providing a player with a plurality of differing games of chance, at least some of which are mutually concurrently playable on a single screen display of a gaming device and enabling mutually concurrent play of the plurality of differing games of chance on the single screen display.

U.S. Pat. No. 6,709,331 (Berman) teaches a method and apparatus for aggregately playing multiple gaming activity events en masse, where the gaming activity events would otherwise require participation in a successive fashion. An aggregate play mode is initiated, and a number of gaming activity events to be associated with the aggregate play is identified. A random number set is generated for each gaming activity event included in the aggregate play, where each random number set corresponds to an individual payout result for its respective gaming activity event. A collective payout result is provided, which includes all of the individual payout results associated with the aggregate play.

United States Patent Application No. 20080214297 (Okada) provides multiple slot game areas on a liquid crystal display. Among the respective slot game areas, the areas to be activated are determined in accordance either with a number of bet credits or with a number of inserted medals. Slot games are executed in the activated slot game areas.

United States Patent Application No. 20080214296 (Okada) provides a slot machine that comprises a display which is provided with plural slot game areas. A player can place a bet automatically on a next slot game on each of predefined slot game areas among the plural slot game areas to play slot games continuously. The player can enjoy plural slot games continuously without a cumbersome betting operation on each game play.

United States Patent Application No 20080214296 (Yoshizawa) provides multiple slot game areas on a liquid crystal display. Among the respective slot game areas, the slot games areas to be activated are determined in accordance either with a number of bet credits or with a number of inserted medals. Then, slot games are executed simultaneously in the activated slot game areas and are terminated simultaneously.

United States Patent Application No. 20080161092 (Yoshizawa) provides multiple slot game areas on a liquid crystal display. Among the respective slot game areas, the slot games areas to be activated are determined in accordance with a number of bet credits or with a number of inserted medals. Then, slot games are executed in the respective slot game areas sequentially with predetermined time lags.

United States Patent Application No. 20080153572 (Yoshizawa) provides multiple slot game areas on a liquid crystal display. Among the respective slot game areas, the areas to be activated are determined in accordance either with a number of bet credits or with a number of inserted medals. Slot games are executed in the activated slot game areas. When payouts are generated in some of the slot games, a total amount of these payouts is provided.

United States Patent Application No. 20080113755 (Rasmussen, et al.) comprises a gaming machine for playing a wagering game that includes a housing having a display region. A first image display device for simulating mechanical reels of a slot machine in the display region includes a curved surface that approximates the radius of curvature of a mechanical reel. The curved surface displays first video images that include a plurality of symbols indicating a randomly selected outcome of the wagering game. A second image display device displays second video images spatially separated from and overlaying the first video images within the display region. The second video images include indicia related to the wagering game.

United States Patent Application No. 20080099987 (Schultz) teaches a game and method having a plurality of indicia sets including multiple supplemental games. Each supplemental game has a set of indicia unique from the indicia sets of the other supplemental games.

United States Patent Application No. 20080090640 (Okada) teaches a plurality of slot machines, wherein when a predetermined condition is satisfied in a basic game, a right to execute a second game is generated, and a second game starting signal for requesting the start of the second game is transmitted to a center controller. When the second game starting signal is received from at least one of the plurality of slot machines, and the predetermined condition is satisfied, the center controller starts the second game for the slot machine which has transmitted the second game starting signal, and performs control for changing the payout of the second game to be executed on the slot machine according to a bet made in the second game on the second game device.

United States Patent Application No. 20080085756 (Okada) teaches a plurality of slot machines, wherein when a predetermined condition is satisfied in a basic game, the slot machine acquires a right to execute a second game, and transmits, to a center controller, a second game start request signal for requesting a start of the second game. When the center controller receives the second game start request signal from at least one of the plurality of slot machines and a predetermined start condition is satisfied, the center controller performs control for starting the second game for each slot machine which has transmitted the second game start request signal, and for changing the payout of the second game for each slot machine according to a result of the basic game.

United States Patent Application No. 20080076524 (Ghaly) discloses an interactive slot machine method and apparatus that does not employ pay lines, and has a playfield that is subdivided into a plurality of groups. The configuration of the groups could be done manually by the player, or at random, and changes for each game. At least one key group is used to define key symbols that must be repeated at other groups for a winning combination of symbols to occur.

United States Patent Application No. 20080064469 (Okada) describes a game system including: slot machines each including a controller which controls at least a basic game and a second game and being capable of making a transition to the second game when a predetermined condition is established in the basic game; a second game device which is provided as a physically separate device from the slot machines and performs the second game; a display adapted to display an image according to a game status of the second game, the display being visible from a plurality of players who are playing the second game at the slot machines and the second game device; and a center controller capable of communicating with the slot machines, second game device, and display. When the predetermined condition is established in the basic game executed at the plurality of slot machines, rights to execute the second game are generated, and second game starting request signals requesting execution start of the second game are sent. When the center controller receives the second game starting request signals and a predetermined start condition is established, the center controller causes the second game device to start the second game for the slot machines which have sent the second game starting request signals.

United States Patent Application No. 20080064468 (Okada) comprises a game system that includes: a plurality of slot machines each including a controller which controls at least a basic game and a second game and being capable of making a transition to the second game when a predetermined condition is established in the basic game; a second game device performing the second game, the second game device being provided as a physically separate device from the slot machines; a display adapted to display an image according to a game status of the second game, the display being visible from a plurality of players who are playing the second game at the slot machines and the second game device; and a center controller capable of communicating with the slot machines, the second game device, and the display. When a predetermined condition is established at least one of the plurality of slot machines, the center controller being operable to, when receiving the second game starting signal from at least one of the plurality of slot machines, the right to execute the second game is given to the slot machine, and it is determined based on an operation input from the player whether to exercise the right to execute the second game. When receiving the signal indicating that the slot machine does not exercise the right to execute the second game, the center controller gives consideration of the second game.

United States Patent Application No. 20080032783 (Walker, et al.) discloses a gaming device and method wherein the gaming device initiates a paid play, and determines an outcome of the play. The outcome is visually displayed using at least two graphical displays. The graphical displays comprise a first and second visual continuum, without discrete reel stops. The outcome is represented by the relative positions of the first and second visual continuums. The outcome may also be based on the relative position of the first and second continuums to a payline. A payout corresponding to the outcome is determined by the device, and is awarded to the player.

United States Patent Application No. 20060287058 (Resnick, et al.) provides methods and devices for presenting a plurality of game elements on one or more display devices. The game elements may comprise, for example, bingo cards, playing cards, hands of playing cards, etc. Some implementations of the invention involve displaying a plurality of game elements as surfaces of a three-dimensional object. Preferably, the orientation of the three-dimensional object can be varied to display selected game elements. The game elements may be selected by a player and/or by a logic device. In some implementations, the three-dimensional object comprises a “carousel” that can be re-oriented (e.g., rotated) to display game elements.

United States Patent Application Nos. 20060194629, 20060189363 and 20050043080 (Strom) teach a wagering machine displaying at least a single payline of multiple frames influenced by at least two distinct indicators; a processor determining from one displayed distinct indicator on the payline whether the symbols provide at least one of at least two available different odds on the wager that are associated with an award; providing a second set of indicators associated with the payline, individual members of the second set of indicators associated with individual frames wherein predetermined combinations and/or orders of the second set of indicators are winning combinations and/or orders based on the wager; and providing the player with at least one award providing a specific multiple of at least some awards based upon the second set of indicators displayed on the payline.

United States Patent Application No. 20060116191 (Vancura) provides a method for operating two different bonus games in a casino game machine.

United States Patent Application No. 20050030295 (Muir) teaches an electronic device that includes an electronic display, a touch screen overlay disposed over a display surface of the electronic display and a photosensor disposed adjacent to the touch screen overlay and the display surface. The device further includes a memory and a controller coupled to the electronic display, the touch screen overlay, the photosensor and the memory. The controller is programmed to display an alignment object having a plurality of electronically distinguishable regions on the display surface of the electronic display and to use the photosensor to detect a characteristic of one of the regions of the alignment object. Additionally, the controller is programmed to move the alignment object based on the detected characteristic along a search path toward an aligned condition with respect to the photosensor.

United States Patent Application No. 20050071023 (Gilliland, et al.) teaches an apparatus and method for displaying multiple gaming device interfaces for the same wagering game. The game can be slot although other wagering games are also within the scope of the present invention. In one embodiment, the exact same game is played using one of a plurality of different display interfaces, wherein the gaming device enables the player to select which interface to play. The player can play the game for a while using one interface and then switch interfaces to provide a fresh display or to change the player's luck. The player can then switch back to the original interface or select a brand new interface depending upon how many interfaces overall are provided.

Despite the above referenced prior art, there remains a need for new game features that will stimulate the gaming public. It is desirable to create less repetitive slot games while still providing more games per hour.

### SUMMARY OF THE INVENTION

A slot machine processor and a video monitor screen are provided on which symbols may be provided in a grid or other orthagonal format for use in a video slot game. The game preferably utilizes a 3-row by 5-reel configuration comprising 15 symbol areas, and preferably consists of at least three game stages, each game stage preferably being a separate game event that may utilize a separate game interface and that may require a separate wager. Different and separate predetermined sets of symbols are provided for at least two game stages in the play of the game. A first symbol set is provided for the first game stage, the first symbol set comprising at least one specifically-themed symbol. A second symbol set is provided for the second game stage, the second symbol set comprising at least one specifically-themed symbol that is predeterminedly-related to the at least one specifically-themed symbol in the first symbol set. Symbols in the third game stage may be a combination of symbols from the first and second symbol sets. The player makes a total wager to play the game; the total wager may or may not consist of equal wagers for each of the three game stages. In the first game stage, a first array of symbols (comprised from the first symbol set) is displayed in the grid, preferably by all reels spinning and stopping to reveal a final first array of symbols. This final first symbol display is then analyzed by the processor, and any winning symbol combinations are paid according to a predetermined paytable. In the second stage, the reels automatically spin again, causing the final first symbol array to disappear from view, and a second array of symbols (comprised from the second symbol set) is displayed in the same grid. This final second symbol display is then analyzed by the processor, and any winning symbol combinations are paid according to a predetermined paytable. In the third stage immediately following, the second symbol array may remain displayed in the grid, and the first symbol array may “reappear” underneath the second symbol array so that both symbol sets may be simultaneously displayed in their original final positions in the same grid, thereby providing a third symbol array comprising combination symbols. This final third symbol display is then analyzed by the processor, and any combination symbol that comprises predeterminedly-related symbols and herein referred to as a “Combination Win” is paid according to the rules of the wagering game. The second symbol need not be precisely underneath the first symbol but may be adjacent to the symbol within the frame or the frame split (which is easily done with electronic video game displays). The second symbol may or may not have a well known or established relationship to the first symbol and the two symbols may or may not interact to provide a payout or enhanced payout. For example, if the first symbols were dogs, the second symbols might be apparel, and only dog-appropriate apparel (e.g., a collar, leash, etc.) or any combination of inappropriate apparel may be used in determining payout amounts after both sets of symbols have been displayed and if the sets of symbols may be combined to determine a payout.

### BRIEF DESCRIPTION OF THE FIGURES

FIG. 1 shows a monitor screen of a slot machine with the results of a previous game.

FIG. 2 shows the a total wager being placed to play three game stages, and the reels spinning.

FIG. 3 shows the results of the first game stage.

FIG. 4 shows the payouts for the first game stage.

FIG. 5 shows the reels automatically spinning again.

FIG. 6 shows the results of the second game stage.

FIG. 7 shows the payouts for the second game stage.

FIG. 8 shows the results of the third game stage.

FIG. 9 shows analysis of the third game stage.

FIG. 10 shows the payouts for the third game stage.

### DETAILED DESCRIPTION OF THE INVENTION

A slot machine processor and a video monitor screen are provided on which symbols may be provided for use in a video slot game. The symbols may be positioned in a grid, preferably as a matrix of rows and columns (or reels) comprised of symbol-bearing areas, or may be positioned in other symmetric, asymmetric or random patterns. The game preferably consists of at least three game stages, each game stage preferably being a separate game that may utilize a separate game interface and that may require a separate wager and based upon a single wager. The three games will always be played, or at least two of the games will always be played based on the single wager. There is no requirement for a predetermined result from an earlier game to advance to a next game in the contiguous series of games. Different and separate predetermined sets of symbols may be provided for at least two continuous game stages in the play of the underlying game. A first symbol set may be provided for a first game stage, the first symbol set comprising at least one specifically-themed symbol. For example, the first symbol set may contain at least one symbol of an animal dwelling, a sports player, a particular casino game, etc. A second symbol set may be provided for a second game stage, the second symbol set comprising at least one specifically-themed symbol that is predeterminedly-related to the at least one specifically-themed symbol in the first symbol set. For example, the second symbol set may contain at least one symbol of an animal, a sports ball, a casino game element, etc. The first symbol set may not comprise specifically-themed symbols contained in the second symbol set, and the second symbol set may not comprise specifically-themed symbols contained in the first symbol set. The first symbol set and the second symbol set may or may not comprise same non-relatable symbols. Symbols in a third game stage may be described as combination symbols comprising preferably one symbol from the first symbol set and one symbol from second symbol set. The player makes an initial total wager to play the game; the total wager may or may not consist of equal wagers for each of the three game stages, and if the initial wager amount is not divisible by the wagered amount, a processor associated with the system will apportion the amounts or base payouts on fractional units of wagers (e.g., on thirds). Preferably the first game stage provides a game interface that provides a 3-row×5-reel grid comprising 15 symbol areas and a predetermined number of wagerable paylines, although other configurations may be utilized. In the first game stage, a first array of symbols (comprised from the first symbol set) is displayed in the grid after the player initiates the play by pressing a Spin button, or otherwise affecting the game to begin. Preferably all reels spin and stop to reveal a final first array of symbols. This final first symbol display is then analyzed by the processor, and any winning symbol combinations on a wagered payline are paid according to a predetermined paytable. Paylines may have to specifically wagered upon or a generic wager will automatically apply to all predetermined paylines and scatter events. Preferably the second game stage provides a game interface that provides the same 3-row×5-reel grid comprising 15 symbol areas and a predetermined number of wagerable paylines. In this second stage, the reels automatically spin again immediately, or virtually immediately, after the result of the first game stage has been resolved; the final first symbol array preferably disappears from view as the reels automatically respin (or may be shaded, minimized or shifted within the frame so that emphasis of view is on the second spin symbols), and a second array of symbols (comprised from the second symbol set) is displayed in the same grid when the reels stop. This final second symbol display is then analyzed by the processor, and any winning symbol combinations on a wagered payline are paid according to a predetermined paytable (at this point, independent from the results of the analysis of the first spin event).

In the third stage immediately following the result and payoff of the second stage, the second symbol array may remain displayed in the same grid, and the first symbol array may “reappear” underneath the second symbol array so that both symbol sets are simultaneously displayed in their original final positions in the same grid, thereby providing a third symbol array comprising combination symbols, each combination symbol comprising exactly two symbols. This third symbol display is then analyzed by the processor, and any combination symbol that comprises predeterminedly-related symbols (i.e., an animal and its related dwelling, a sports ball and its related player, or a casino game and its related element in the same symbol area) are paid according to the predetermined rules of the game. Winning combination symbols may be considered to be “Combination Wins”, and may be considered as scatter pays, multipliers, wild symbols or the like, according to the design, rules and mathematics of the game. For example, a scatter pay Combination Win may be worth a fixed amount of credits, or may be worth a varying amount of credits. Or, for example, a multiplier Combination Win may multiply wins in any, some or all of the game stages. If the Combination Win is considered a wild symbol, for example, each game stage may be reevaluated for wins by substituting that same wild symbol.

In a preferred embodiment of the present invention, a video slot game comprising three distinct and separate game stages is discussed. A slot machine processor and a video monitor screen are provided on which symbols may be provided for use in each of the three game stages. The symbols are preferably positioned in a grid, preferably as a matrix of three rows and five columns (or reels), comprising 15 symbol-bearing areas. Each game stage is preferably a separate game event that utilizes a separate game paytable and distinct screen shots that are accessed through the common interface of the gaming apparatus. Different and separate predetermined sets of symbols are preferably provided for the first two game stages. A first symbol set is provided for the first game event, the first symbol set comprising at least one, but preferably at least three, specifically-themed symbols. For example, the first symbol set may contain at least three symbols of particular animal dwellings (i.e., a doghouse, a fish bowl, a beaver's dam, a birdhouse, etc.). A second symbol set is provided for the second game event, the second symbol set comprising at least one specifically-themed symbol that is predeterminedly-related to the at least one specifically-themed symbol in the first symbol set. For example, the second symbol set may contain at least one, but preferably at least three, symbols of animals (i.e., a dog, a fish, a beaver, a bird, etc.) that are predeterminedly related to that same animal's dwelling symbols (i.e., the doghouse, the fish bowl, the beaver's dam, the birdhouse, etc.) as contained in the first symbol set. Symbols in the third game stage may be a described as combination symbols comprising preferably one symbol from the first symbol set and preferably one symbol from second symbol set. The player makes a total wager to play the game; the total wager may or may not consist of equal wagers for each of the three game stages. Preferably the first game stage provides a game interface that provides a 3-row×5-reel grid comprising 15 symbol areas and a predetermined number of wagerable paylines. In the first game stage, a first array of symbols (comprised from the first symbol set) is displayed in the grid after the player initiates the play by pressing a Spin button, or otherwise affecting the game to begin. Preferably all reels spin and stop to reveal a final first array of symbols. This final first symbol display is then analyzed by the processor, and any winning symbol combinations on a wagered payline are paid according to a predetermined paytable. Preferably the second game stage provides a game interface that provides the same 3-row×5-reel grid comprising 15 symbol areas and a predetermined number of wagerable paylines. In this second stage, the reels automatically spin again immediately, or virtually immediately, after the result of the first game stage has been resolved; the final first symbol array disappears from view as the reels automatically respin, and a second array of symbols (comprised from the second symbol set) is displayed in the same grid when the reels stop. This final second symbol display is then analyzed by the processor, and any winning symbol combinations on a wagered payline are paid according to a predetermined paytable. In the third game stage immediately following the result and payoff of the second stage, the second symbol array remains displayed in the grid, and the first symbol array “reappears” underneath the second symbol array so that both symbol sets are simultaneously displayed in their original final positions in the same grid, thereby providing a third symbol array comprising combination symbols, each combination symbol comprising exactly two symbols. This third symbol display is then analyzed by the processor, and any combination symbol that comprises predeterminedly-related symbols (i.e., a dog and a doghouse, a fish and a fishbowl, a beaver and a dam, or a bird and a birdhouse in the same symbol area) is considered a winning combination symbol. Winning combination symbols are paid according to the predetermined rules of the game.

Reference to all of the Figures will assist in further understanding of the practice of the present invention.

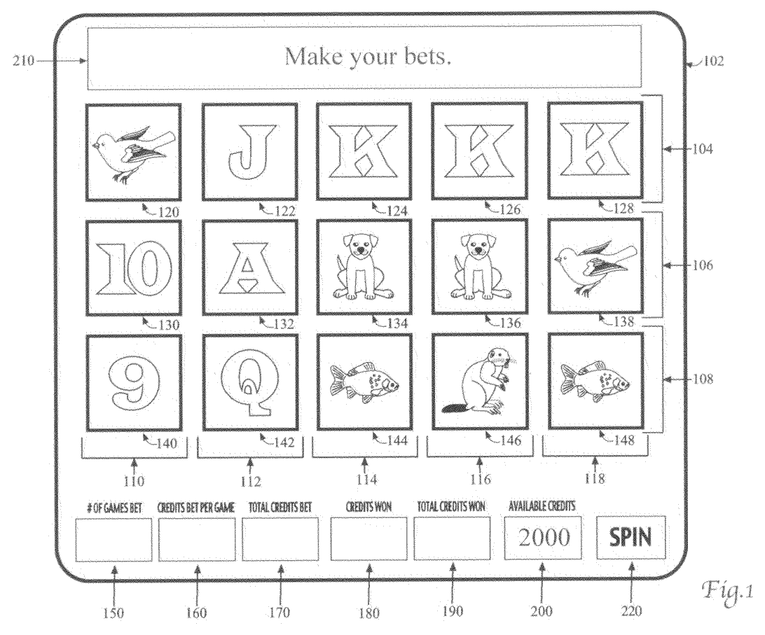

FIG. 1 shows a slot machine monitor screen 2 with the result of a previously completed game. Fifteen individual symbol areas (120, 122, 124, 126, 128, 130, 132, 134, 136, 138, 140, 142, 144, 146, 148) are arranged in a three-row (104, 106, 108) by five-reel (110, 112, 114, 116, 118) matrix. Six indicator windows are shown on the monitor screen 2 including Number of Games (Stages) Bet 150, Number of Credits Bet Per Game (Stage) 160, Total Credits Bet 170, Credits Won Per Game (Stage) 180, Total Credits Won 190 and Available Credits 200. Two thousand credits are shown to be available. A message window 210 is provided, here indicating to the player that a wager may be placed at this time. A Spin button 220 is also shown.

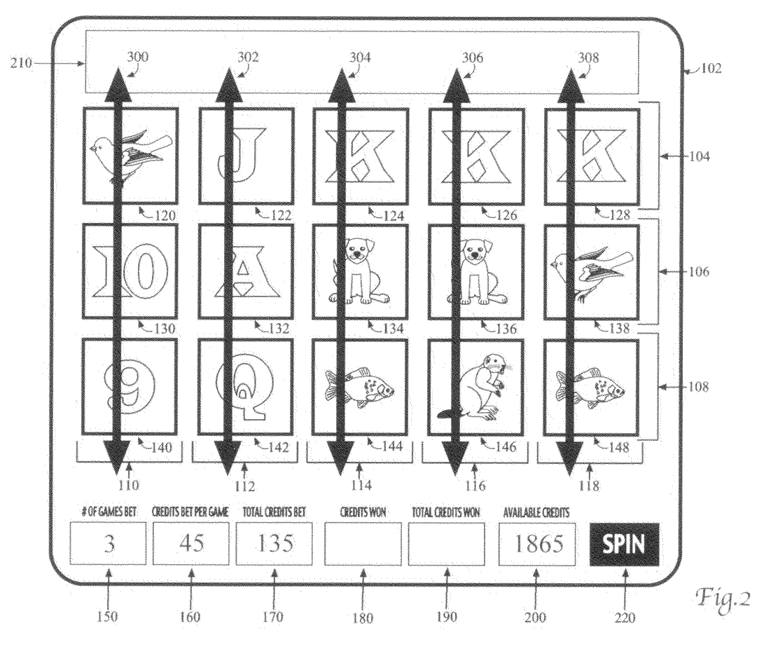

FIG. 2 refers to the game elements shown in FIG. 1 with the indicator windows showing that 3 games are being wagered 150 at 45 credits per game 160, for a total of 135 credits bet 170. After subtracting the total wager 170, 1865 available credits 200 are now shown, the player has pressed the Spin button 220, and the reels have begun to spin (300, 302, 304, 306, 308).

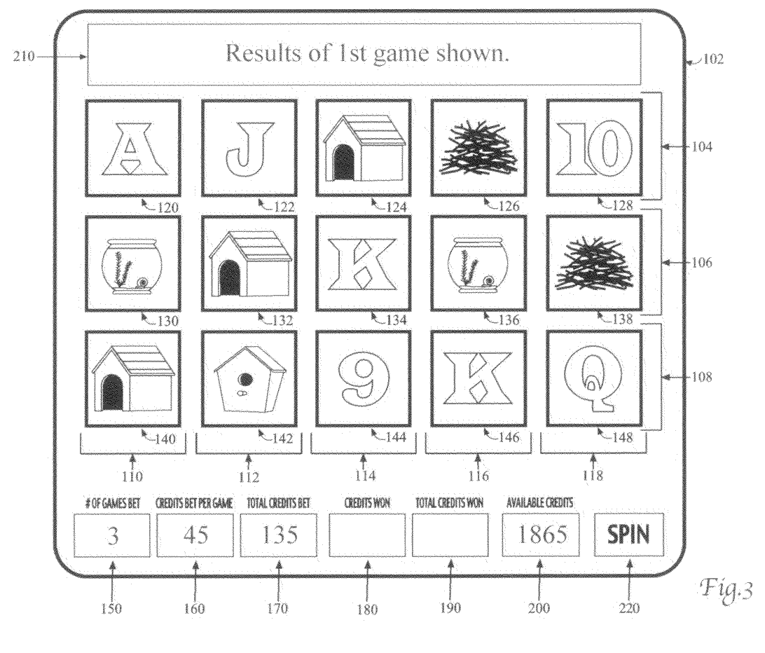

FIG. 3 refers to the game elements shown in FIG. 2, with the reels having stopped, and the message window 210 announcing that the result of the first game is now shown. The fifteen individual symbol areas show two distinct types of symbols from a first symbol set: non-relatable basic poker symbols (A, K, Q, J, 10, 9) as shown in symbol areas 120, 122, 128, 134, 144, 146, and 148; and relatable animal dwelling symbols (doghouse, beaver dam, fishbowl, birdhouse) as shown in symbol areas 124, 126, 130, 132, 136, 138, 140 and 142.

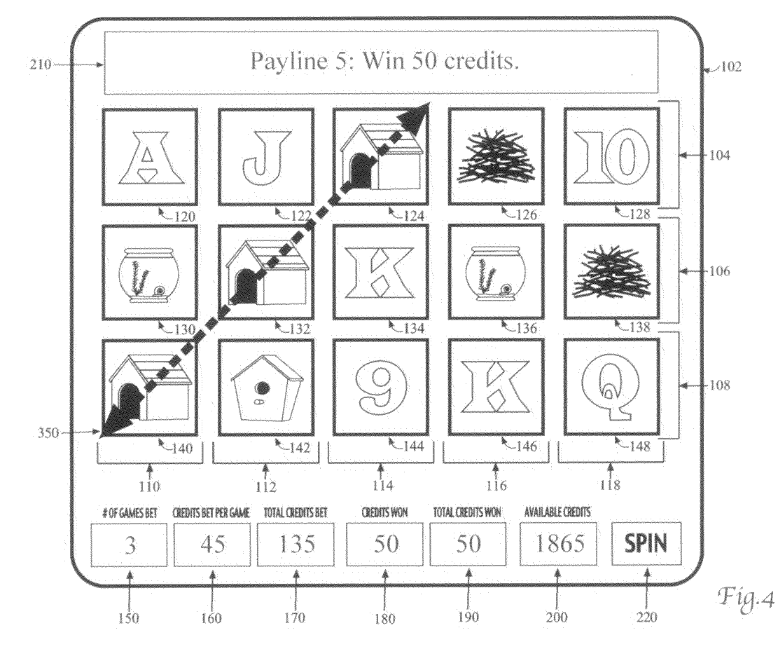

FIG. 4 refers to the game elements shown in FIG. 3 with the doghouse symbols in symbol areas 140, 132, and 124 being highlighted by an arrow on Payline 5 350 and the win being announced in the message window 210. Fifty credits are shown in the Credit Won Per Game window 180, and in the Total Credits Won window 190.

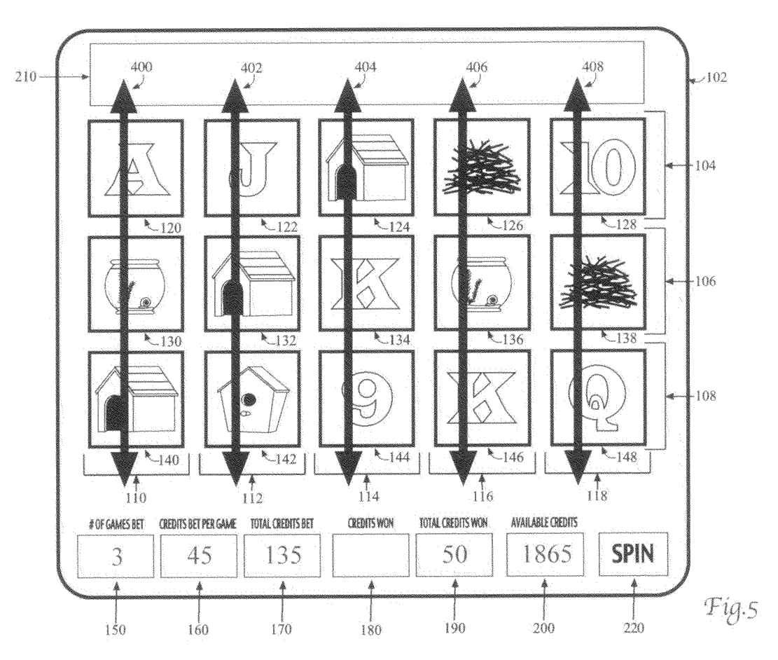

FIG. 5 refers to the game elements shown in FIG. 4 with the reels automatically spinning (400, 402, 404, 406, 408) to begin the second game. Since the Spin button 220 is not spun by the player in order to play Game 2, no additional time on machine is wasted between Game 1 and Game 2. The Credits Won Per Game window 180 is again blank.

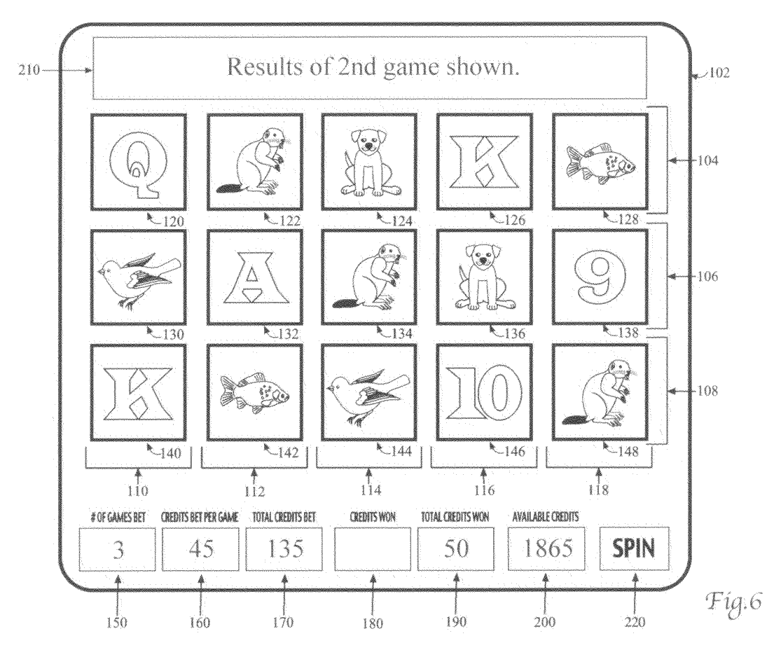

FIG. 6 refers to the game elements shown in FIG. 5, with the reels having stopped, and the message window 210 announcing that the result of the second game is now shown. The fifteen individual symbol areas show two distinct types of symbols from a second symbol set: non-relatable basic poker symbols (A, K, Q, J, 10, 9) as shown in symbol areas 120, 126, 132, 138, 140, and 146; and relatable animal symbols (dog, beaver, fish, bird) as shown in symbol areas 122, 124, 128, 130, 134, 136, 142, 144 and 148.

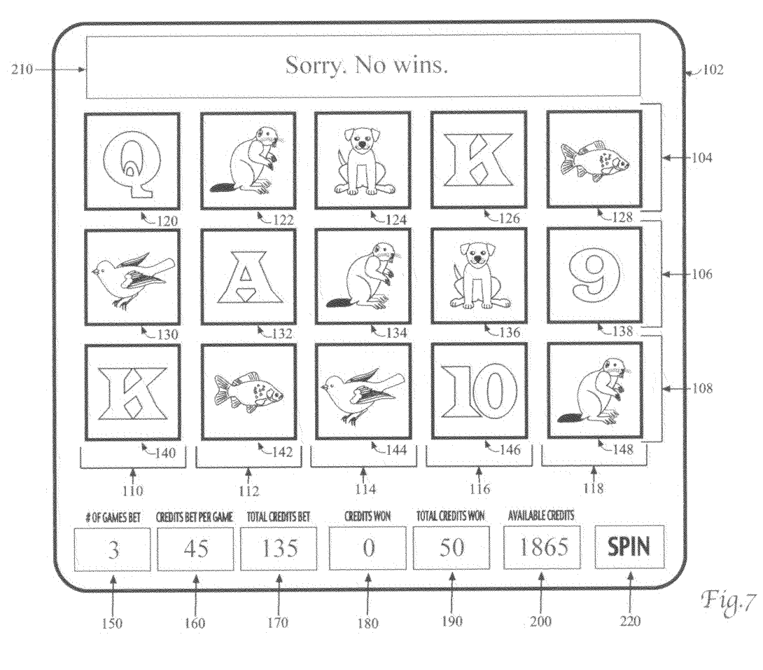

FIG. 7 refers to the game elements shown in FIG. 6 with the message window 210 announcing no wins and zero credits being shown in the Credit Won Per Game window 180. The Total Credits Won window 190 remains at fifty.

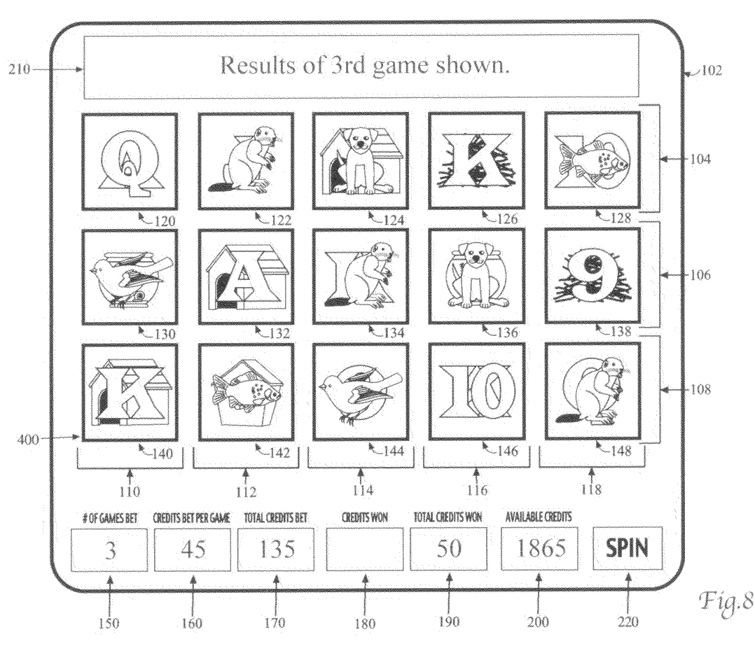

FIG. 8 refers to the game elements shown in FIG. 7, with the symbols from Game 2 remaining, the symbols from Game 1 (see FIG. 3) reappearing, and the message window 210 announcing that the result of the third game is now shown. Since the Spin button 220 is not spun by the player in order to play Game 3, no additional time on machine is wasted between Game 2 and Game 3. The Credits Won Per Game window 180 is again blank. The fifteen individual symbol areas (120, 122, 124, 126, 128, 130, 132, 134, 136, 138, 140, 142, 144, 146, 148) now each show a resultant symbol in Game 2 superimposed over a resultant symbol in Game 1, with each single symbol displayed in its original final result position.

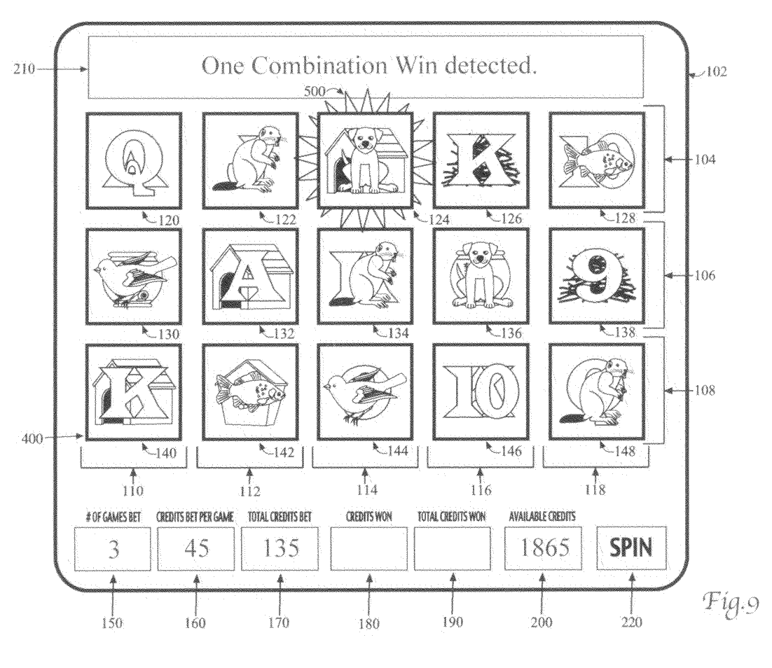

FIG. 9 refers to the game elements shown in FIG. 8 with the processor analyzing the symbol combinations in each symbol area, and searching for any symbol area that contains a symbol from the first symbol set that is predeterminedly related to the symbol from the second symbol set in the same symbol area (herein designated “Combination Win”). Here the processor is analyzing each symbol box for a Combination Win, specifically searching for an animal symbol that appears with its related animal dwelling symbol. The message window 210 is shown announcing that one Combination Win has been detected in symbol area 124, the dog and doghouse symbols being highlighted by a starburst 500.

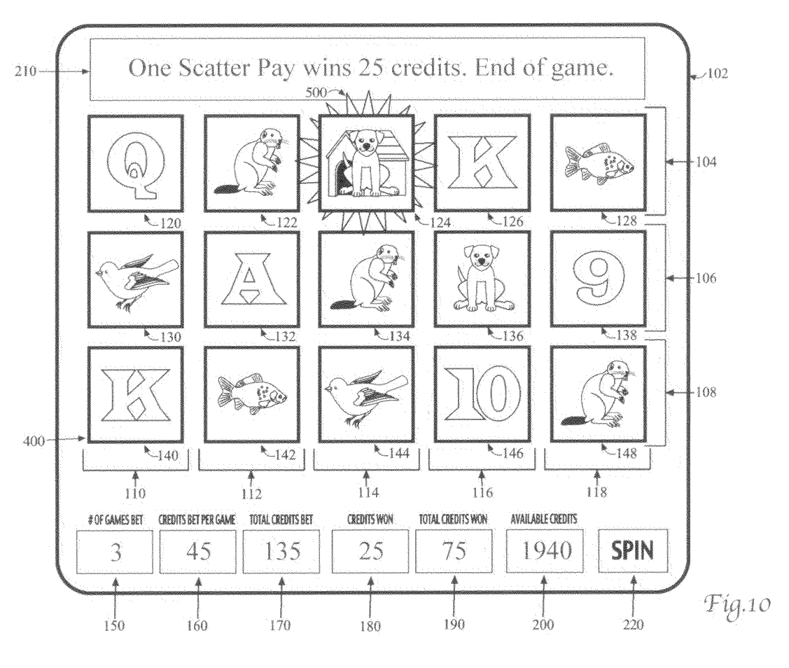

FIG. 10 refers to the game elements shown in FIG. 9 with the message window 210 is shown announcing that the Combination Win in symbol area 124 is a Scatter Pay that pays 25 credits. Twenty-five credits are shown in the Credits Won Per Game window 180, the Total Credits Won window 190 now shows a total of 75 credits have been won in the 3-stage game, and the 75 credits have been added to the Available Credits 200.

Those trained in the art will appreciate that these play options are exemplary and are not intended to dictate an exclusive method of play, nor limit or restrict specific gameplay. Although specific examples and specific images have been provided in this discussion, these specifics are intended to be only support for the generic concepts of the invention and are not intended to be absolute limits in the scope of the technology discussed.

What is claimed:

1. A method of playing a video wagering game on a gaming apparatus with a video display comprising:
a player placing a wager through the gaming apparatus;
the gaming apparatus providing a first set of symbols in available symbol display areas on the video display;
a processor determining whether the first set of symbols is a predetermined winning event;
if the first set of symbols is a winning event, crediting the player with a win amount and then proceeding to a next set of displayed symbols, and if the set of symbols is not a winning event, proceeding to a next set of displayed symbols;
displaying a second set of displayed symbols on the video screen;
the processor determining whether the second set of symbols being independent of the first set of symbols is a predetermined winning event;
if the second set of symbols is a winning event, crediting the player with a win amount and then proceeding to display the first set of symbols along with the second set of symbols, and if the second set of symbols is not a winning event, proceeding to display the first set of symbols along with the second set of symbols;
determining if a combination of the first set of symbols and second set of symbols forms a predetermined winning event; and
resolving the wager and awarding any amounts won.

2. The method of claim 1 wherein as the second set of displayed symbols is being displayed, the first set of symbols is hidden after they have been displayed.

3. The method of claim 1 wherein the first set of symbols and the second set of symbols are shown in a same set of frames.

4. The method of claim 2 wherein the first set of symbols and the second set of symbols are shown in a same set of frames.

5. The method of claim 1 wherein as the second set of displayed symbols is being displayed, the first set of symbols is diminished after they have been displayed.

6. The method of claim 5 wherein the first set of symbols and the second set of symbols are shown in a same set of frames.

7. A gaming system comprising:
a housing;
a video display system;
a processor;
player input interface enabling a player to enter wagers in a wagering game; and
the processor containing executable software to allow a player at the player interface to play the method of claim 1 as the wagering game.

8. A gaming system comprising:
a housing;
a video display system;
a processor;
player input interface enabling a player to enter wagers in a wagering game; and
the processor containing executable software to allow a player at the player interface to play the method of claim 2 as the wagering game.

9. A gaming system comprising:
a housing;
a video display system;
a processor;
player input interface enabling a player to enter wagers in a wagering game; and
the processor containing executable software to allow a player at the player interface to play the method of claim 3 as the wagering game.

10. A gaming system comprising:
a housing;
a video display system;
a processor;
player input interface enabling a player to enter wagers in a wagering game; and
the processor containing executable software to allow a player at the player interface to play the method of claim 4 as the wagering game.

11. A gaming system comprising:
a housing;
a video display system;
a processor;
player input interface enabling a player to enter wagers in a wagering game; and
the processor containing executable software to allow a player at the player interface to play the method of claim 5 as the wagering game.

12. A gaming system comprising:
a housing;
a video display system;
a processor;
player input interface enabling a player to enter wagers in a wagering game; and
the processor containing executable software to allow a player at the player interface to play the method of claim 6 as the wagering game.
